(19) United States
(12) Patent Application Publication
(10) Pub. No.: US 2015/0244664 A1
(43) Pub. Date: Aug. 27, 2015

(54) ENTERPRISE MESSAGING PLATFORM

(71) Applicant: EyeSay, LLP, San Francisco, CA (US)

(72) Inventor: Dorian Kendal, San Francisco, CA (US)

(21) Appl. No.: 14/188,050

(22) Filed: Feb. 24, 2014

(51) Int. Cl. H04L 12/58; H04W 4/12; H04L 29/08; H04W 4/02

(52) U.S. Cl. CPC H04L 51/14; H04W 4/02; H04W 4/12; H04L 67/22; H04L 67/306

(57) ABSTRACT

In at least one embodiment, a method of operating a messaging platform system is disclosed. The method can include: receiving a login from a first user account to the messaging platform system from a terminal, the login including login information; determining a terminal type based at least partly on the login information; monitoring for a user action at the terminal; receiving an incoming message for the first user account from a second user account; and determining whether to push the incoming message to a destination device associated with the first user account based on the monitoring of the user action and the terminal type.

### RELATED FIELD

This disclosure relates to a messaging platform system and particularly to an enterprise messaging platform.

### BACKGROUND

With the increased popularity of mobile phones and especially mobile smart phones, texting has become one of the prevalent ways for people to communicate with one another. Mobile text messages are often preferred for its simplicity. Further, mobile text messages are preferred because unlike normal phone calls, a mobile text message can be sent to multiple people at the same time. Even if a mobile text message is not sent to multiple people at the same time, users can enjoy multiple conversations simultaneously when they are text messaging. This is usually more difficult in a phone conversion or when talking in person.

The benefits of mobile messaging can equally apply to a professional setting. However, existing messaging platforms in an enterprise setting struggle to provide flexible and convenient usage for its users given the constraints of the enterprise setting.

### BRIEF DESCRIPTION OF THE DRAWINGS

FIG. 1 is a block diagram of an exemplary system environment of a messaging platform system, in accordance with various embodiments.

FIG. 2 is a block diagram of another exemplary system environment of a messaging platform system, in accordance with various embodiments.

FIG. 3 is a state diagram illustrating transitions of message delivery mechanisms for devices associated with a first user account in a messaging platform system.

FIG. 4 illustrates a flowchart of a method of operating a messaging platform system for message delivery mechanism transition, in accordance with various embodiments.

FIG. 5 illustrates a flowchart of a method of operating a messaging platform system for enterprise-level broadcast, in accordance with various embodiments.

FIG. 6 illustrates a flowchart of a method of operating a messaging platform system for configuring “hot buttons” in an enterprise messaging platform, in accordance with various embodiments.

FIG. 7 illustrates a flowchart of a method of operating a messaging platform system to centralize conversation storage, in accordance with various embodiments.

FIG. 8 illustrates a flowchart of a method of operating a message platform interface on a computing device to prevent unauthorized screen captures of enterprise conversation, in accordance with various embodiments.

FIG. 9 is a diagrammatic representation of a machine in the example form of a computer system within which a set of instructions, for causing the machine to perform any one or more of the methodologies or modules discussed herein, may be executed.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

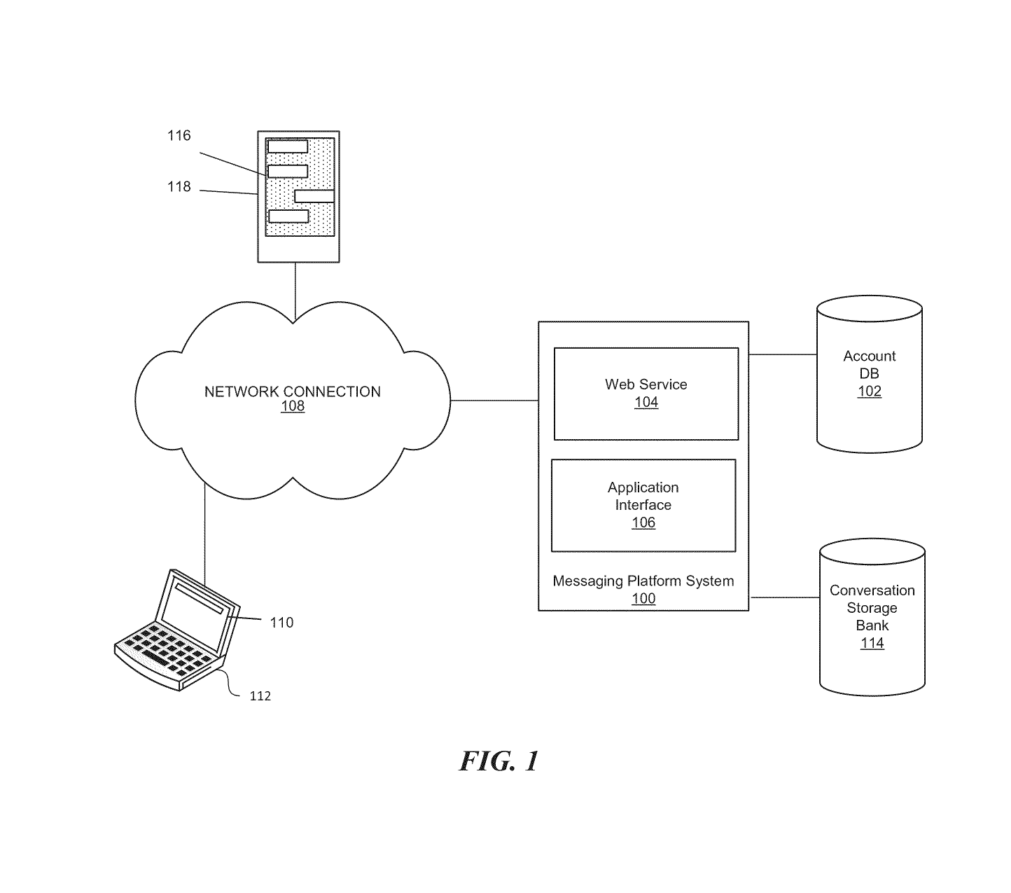

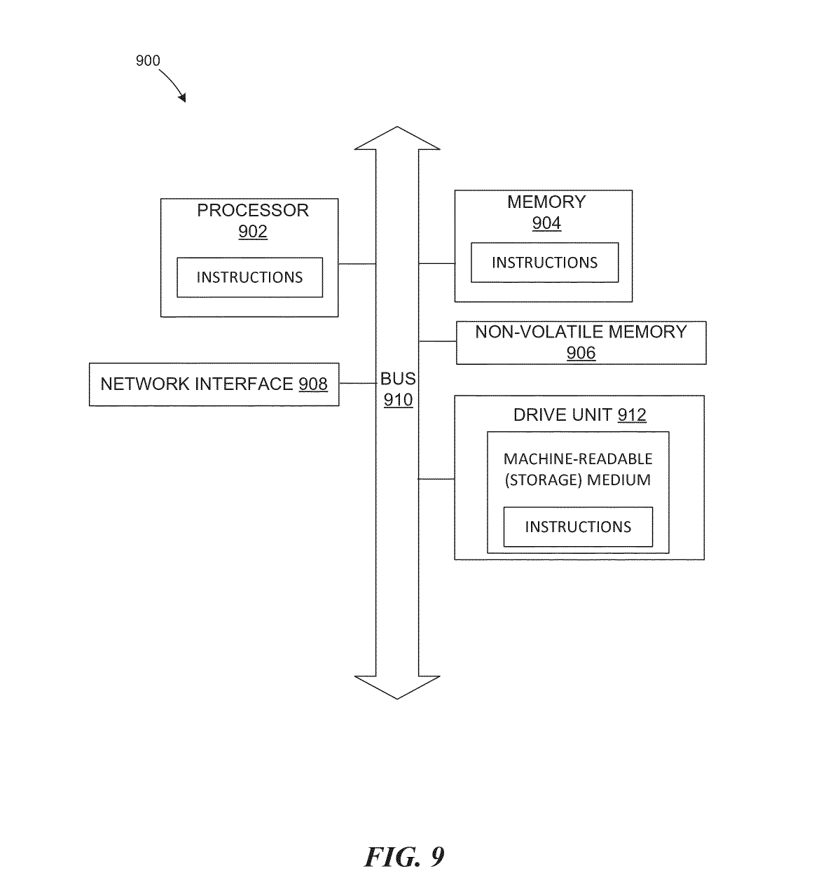

FIG. 1 is a block diagram of an exemplary system environment of a messaging platform system 100, in accordance with various embodiments. Embodiments of the present disclosure include systems and methods for operating a messaging platform system for managing multimedia text messages within an exclusive messaging community. The messaging platform system 100 may be implemented as a computer system 900 of FIG. 9. The messaging platform system 100 may be implemented by one or more computer servers, computer clusters, cloud server services, or any other combination of devices.

The messaging platform system 100 can include an account database 102. The account database 102 keeps track of user accounts in the exclusive messaging community. The account database 102 also records special privileges of a subset of the user accounts. For example, at least one of the user accounts can be an admin account capable of configuring message platform interfaces, adding and removing members from the exclusive messaging community, accessing archival conversations (e.g., subject to a privacy policy of the exclusive messaging community), or any combination thereof. As another example, at least one of the user accounts can be a power user account granted with special privileges, such as broadcasting messages to every user account in the exclusive messaging community even when the power user account does not have a contact group that includes every user account in its contact list.

The messaging platform system 100 may include a web service module 104 and an application interface module 106. Each of the modules can be implemented by one or more computing devices, such as computer servers. For example, the modules described can be implemented as instructions on a tangible storage memory capable of being executed by a processor or a controller in the computing devices. The tangible storage memory may be volatile or non-volatile memory. In some embodiments, the volatile memory may be considered “non-transitory” in the sense that it is not transitory signal. Modules may be operable when executed by a processor or other computing device, e.g., a single board chip, application specific integrated circuit, a field programmable field array, a network capable computing device, a virtual machine terminal device, a cloud-based computing terminal device, or any combination thereof. Memory spaces and storages accessible to the modules can be implemented with the tangible storage memory as well, including volatile or non-volatile memory.

Each of the modules may operate individually and independently of other modules or components. Some or all of the modules may be executed on the same host device or on separate devices. The separate devices can be coupled together through one or more communication channels (e.g., wireless or wired channel) to coordinate their operations. Some or all of the components and/or modules may be combined as one component or module.

A single module may be divided into sub-modules, each sub-module performing separate method step or method steps of the single module. In some embodiments, at least some of the modules share access to a memory space. For example, one module may access data accessed by or transformed by another module. The modules may be considered “coupled” to one another if they share a physical connection or a virtual connection, directly or indirectly, allowing data accessed or modified from one module to be accessed in another module.

The web service module 104 may be coupled to a network connection 108, such as a global network connection (e.g., the Internet) or a local Ethernet network. The web service module 104 may be accessed over the network connection 108 to provide a web message platform interface as one or more webpages accessible through a web browser 110 of a network-enabled device 112. User accounts can log into the messaging platform system 100 through the web message platform interface. User accounts can send messages to one another in the exclusive messaging community via the web message platform interface through the message platform system 100.

Each message can include one or more of text, audio clip, video clip, still image, other multimedia, or any combination thereof. All messages through the web message platform interface can be stored in a conversation storage bank 114 in the messaging platform system 100. The messaging platform system 100 can stream a conversation involving a specific user account to the web browser 110 from which the specific user account is logged in (e.g., in response to a user action on the web message platform interface requesting the conversation). In some embodiments, the conversations are not stored in persistent memory of the network-enabled device 112. That is, the web browser 110 can wipe a conversation of a user account from the browser cache either after the user account logs out or when the web session of the web message platform interface expires.

The application interface module 106 may also be coupled to the network connection 108. The application interface module 106 may be accessed over the network connection 108 to deliver conversations to a message platform interface displayed by an application 116 (e.g., a mobile application) implemented on a mobile device 118. For example, the application interface module 106 can stream a conversation to the mobile device 118 in response to receiving a user action on the application 116 requesting the conversation. The application 116 can also enable the application interface module 106 to push a message or conversation to the mobile device 118 without an active request from the mobile device 118. The message platform interface displayed by the application 116 can be the same or similar to the web message platform interface provided by the web service module 104. User accounts can log into the messaging platform system 100 through the message platform interface of the application 116. User accounts can send messages to one another in the exclusive messaging community via the message platform interface through the messaging platform system 100. This includes a conversation that takes place between a first user using the web message platform interface and a second user using the message platform interface provided by an instance of the application 116. Each message again can include one or more of text, audio clips, video clip, still image, other multimedia, or any combination thereof. All messages through the message platform interface are stored in the conversation storage bank 114.

Messages of conversations can either be pushed to the mobile device 118 or streamed to the mobile device 118 upon request. In some embodiments, the conversations are not stored in persistent memory of the mobile device 118. That is, a native operating system can wipe/clear a conversation of a user account from the operating memory of the mobile device 118 either after the user account logs out or the instance of the application 116 is closed.

The mobile device 118 is an active electronic device with cellular network capabilities. For example, the mobile device 118 can be a smart phone, a tablet, an e-reader, an electronic accessory, a laptop, a computer, or any device with computer functionalities. Two or more of the mobile device 118 can communicate with each other through the messaging platform system 100.

The application 116 can be implemented on a variety of mobile operating systems, including but not limited to the iOS and the Android platforms. The application 116 allows individuals to quickly and easily send multimedia messages to a friend, a group of friends, a colleague, a professional group, a corporate entity, a media storage destination, a social networking destination, a website, or any combination thereof. However these destinations of individuals or groups can only exist within the same exclusive messaging community as an individual who sends a message. Messages become part of conversations that can be replayed at a later time (both sent and received messages).

The application 116 can be downloaded over the network connection 108, such as from an application store, a website linking to an online storage of the application 116, or via a text message link sent from another user of the messaging platform system 100. The mobile device 102 can include a memory for storing the application 116, one or more processors to execute the application 116, and one or more sensors and output devices to implement the message platform interface provided by the application 116.

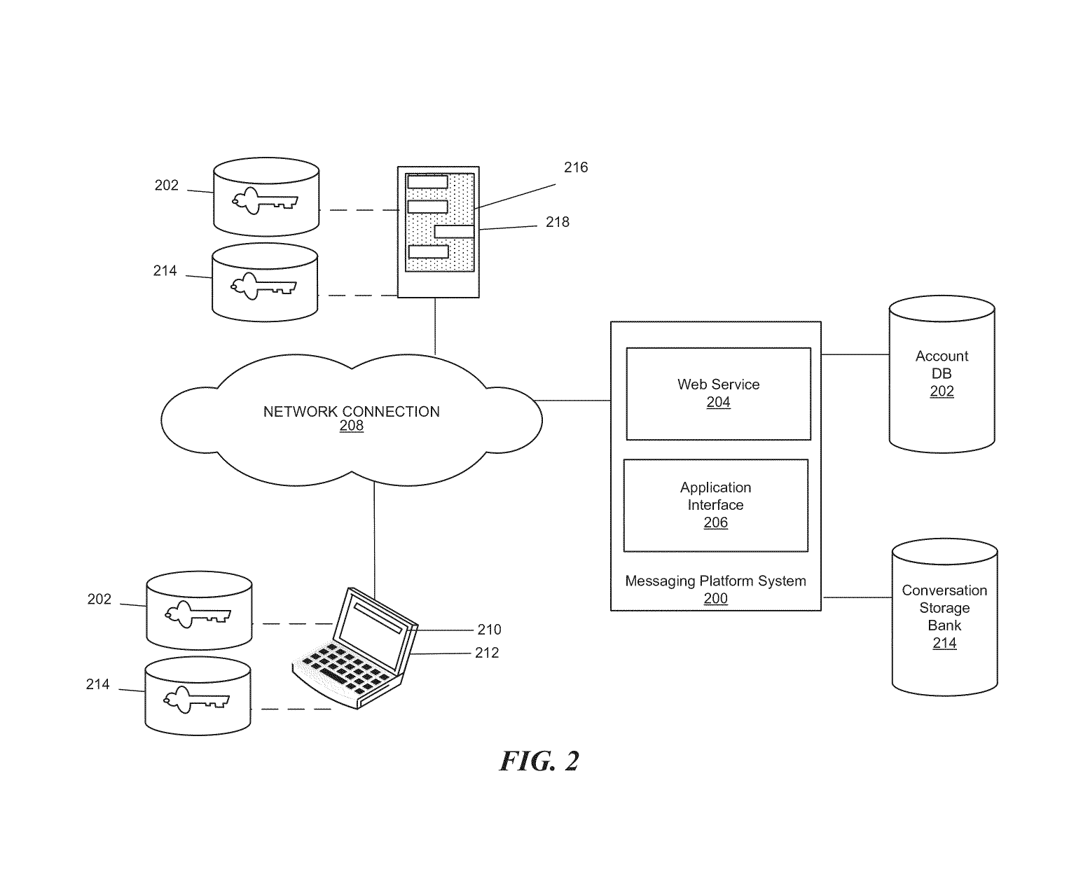

FIG. 2 is a block diagram of another exemplary system environment of a messaging platform system 200, in accordance with various embodiments. The messaging platform system 200 may be implemented as the computer system 900 of FIG. 9. The messaging platform system 200 may be implemented by one or more computer servers, computer clusters, cloud server services, or any other combination of devices.

The messaging platform system 200 can access an account database 202, similar to the account database 102 of FIG. 1. In some embodiments, the account database 202 can be stored in the messaging platform system 200 or externally in a storage server system coupled to the messaging platform system 200. The other embodiments, the account database 202 can be implemented as a distributed storage.

The messaging platform system 200 may include a web service module 204 and an application interface module 206. For example, the web service module 204 can be the web service module 104 of FIG. 1 and the application interface module 206 can be the application interface module 106 of FIG. 1. Each of the modules can be implemented by one or more computing devices, such as computer servers. The web service module 204 may be coupled to a network connection 208, such as the network connection one-way of FIG. 1.

The web service module 204 can provide a web message platform interface as one or more webpages accessible through a web browser 210 of a network-enabled device 212, such as the web browser 110 of the network-enabled device 112 of FIG. 1. User accounts can send messages to one another in the exclusive messaging community via the web message platform interface. Each message can include one or more of text, audio clip, video clip, still image, other multimedia, or any combination thereof. All messages through the web message platform interface can be stored in a conversation storage bank 214.

The application interface module 206 may also be coupled to the network connection 208. The application interface module 206 may be accessed over the network connection 208 to deliver conversations to a message platform interface displayed by an application 216 implemented on a mobile device 218, such as the application 116 implemented on the mobile device 118 of FIG. 1.

User accounts can log into the messaging platform system 200 through the message platform interface of the application 216. User accounts can send messages to one another in the exclusive messaging community via the message platform interface. This includes a conversation that takes place between a first user using the web message platform interface and a second user using the message platform interface provided by an instance of the application 216. Each message again can include one or more of text, audio clips, video clip, still image, other multimedia, or any combination thereof. All messages through the message platform interface are stored in the conversation storage bank 214.

The system architecture of the messaging platform system 200 differs from the messaging platform system 100 in that the account database 202 and the conversation storage bank 214 can be stored in a distributed manner. For example, the account database 202 and/or the conversation storage bank 214 can reside in a cloud storage of servers. As another example, the account database 202 and/or the conversation storage bank 214 can reside in a cloud storage of consumer devices including the mobile device 218. In some embodiments, the cloud storage of consumer devices may include the network-enabled device 212.

The account database 202 and/or the conversation storage bank 214 can be divided into encrypted data fragments. The encrypted data fragments can be later retrieved and decrypted given the proper decryption key. A decryption key to extract a conversation or an account profile is only available to the devices associated with a user account that is involved in the conversation or is the owner of the account profile. In some embodiments, only the messaging platform system 200 can perform the decryption and extraction of the distributed fragments.

In some embodiments, some or all of the functionalities of the web service module 204 and/or the application interface module 206 are implemented in a distributed manner as well. For example, the web service module 204 or the application interface module 206 can be implemented via the application 216. As another example, the web service module 204 or the application interface module 206 can be implemented via browser executable scripts (e.g., flash or JavaScript bundles) that runs on the web browser 210. In these embodiments, the messaging platform system 200 can essentially be a decentralized enterprise messaging platform that exists within a local network.

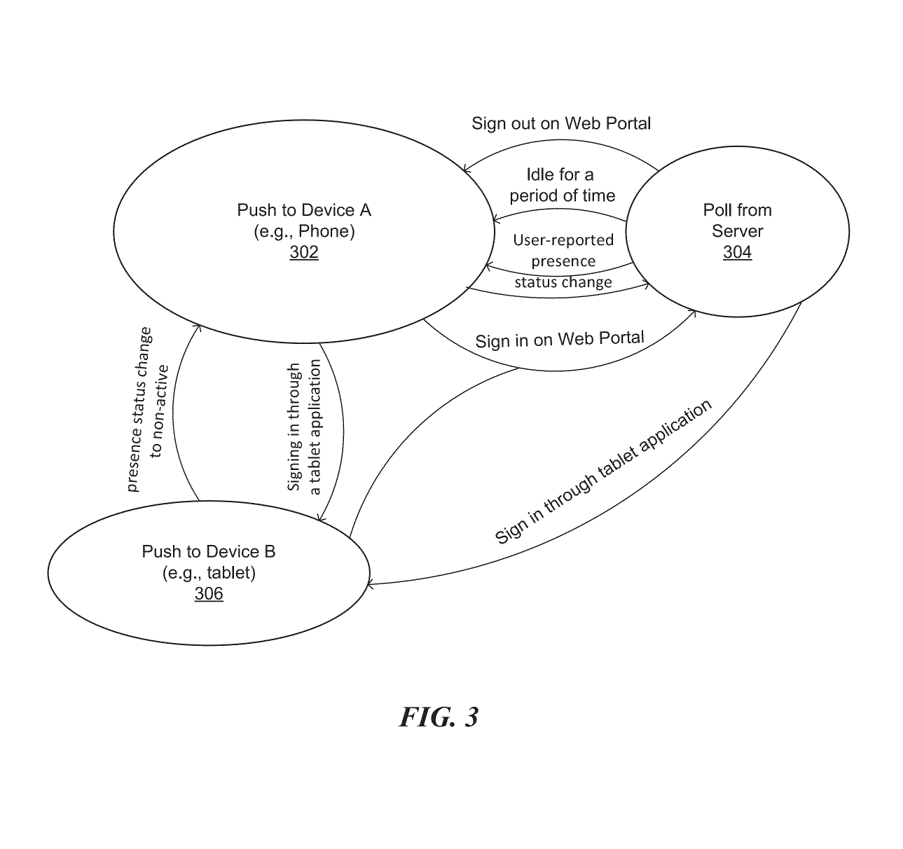

FIG. 3 is a state diagram illustrating transitions of message delivery mechanisms for devices associated with a first user account in a messaging platform system, such as the messaging platform system 100 of FIG. 1 or the messaging platform system 200 of FIG. 2. In the illustrated example, the messaging platform system 100 can maintain at least three different message delivery states for the first user account including: a push-to-device-A state 302, a poll-from-server state 304, and a push-to-device-B state 306.

In the push-to-device-A state 302, the delivery mechanism is an interrupt mechanism. That is, the messaging platform system can “push” a message or a conversation to a device A (e.g., a primary mobile device such as a mobile phone) without an active request from the device A to retrieve the message or conversation. In the poll-from-server state 304, the delivery mechanism is a polling mechanism. That is, the messaging platform system only delivers a message or a conversation to a device that sends an active request for the message or conversation. In the push-to-device-B state 306, the delivery mechanism is an interrupt mechanism similar to the push-to-device-A state 302. The messaging platform system can instead “push” a message or a conversation to a device B (e.g., a secondary mobile device such as a tablet) without an active request from the device B to retrieve the message or conversation.

The messaging platform system can change the delivery mechanism for the first user account in response to monitoring for user actions of the first user account. For example, when the first user account is associated with the push-to-device-A state 302, a user action of signing into the first user account through a web message platform interface can trigger a state transition to the poll-from-server state 304. When the first user account is associated with the poll-from-server state 304, a user action of signing out of the web message platform interface can trigger a state transition to the push-to-device-A state 302. Alternatively, the lack of user action for a period of time (e.g., idling) can cause a state transition from the poll-from-server state 304 to the push-to-device-A state 302. Other types of user actions can also cause the transition between the push-to-device-A state 302 and the poll-from-server state 304. For example, a user-reported presence status change captured from the web message platform interface from “active” to “away from keyboard” can cause a state transition to the push-to-device-A state 302 and a user-reported presence status change from “away from keyboard” to “active” can cause a state transition to the poll-from-server state 304.

Other examples include transitioning to the push-to-device-B state 306 when a user action of signing in through a tablet application is detected at the messaging platform system; transitioning to the poll-from-server state 304 when a user action of signing in through a web portal is detected at the messaging platform system; and transitioning to the push-to-device-A state 302 when a presence status change (e.g., user-reported or determined based on a geolocation from the device A or the device B) to a non-active status is detected at the messaging platform system.

Some embodiments of the disclosure have other aspects, elements, features, and steps in addition to or in place of what is described above. These potential additions and replacements are described throughout the rest of the specification.

### Message Delivery Mechanism Transition

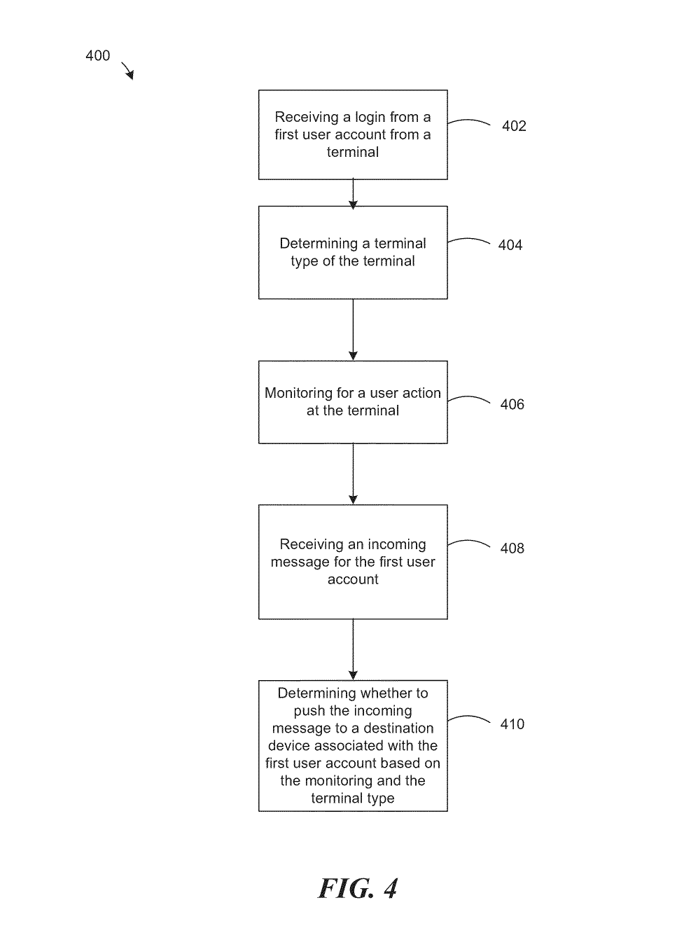

FIG. 4 illustrates a flowchart of a method 400 of operating a messaging platform system for message delivery mechanism transition, in accordance with various embodiments. The method can include: receiving a login from a first user account to the messaging platform system from a terminal, the login including login information at step 402; determining a terminal type based at least partly on the login information at step 404; monitoring for a user action at the terminal at step 406; receiving an incoming message for the first user account from a second user account at step 408; and determining whether to push the incoming message to a destination device associated with the first user account based on the monitoring of the user action and the terminal type at step 410.

In one scenario, the terminal type may be determined to be a web browser on a computing device when the destination device is a mobile device associated with the first user account. In that case, monitoring for the user action at the terminal can include monitoring for the user action within a period of time to determine whether the terminal has gone idle. Subsequently, the messaging platform system can determine to push the incoming message to the destination device when the terminal has gone idle. Alternatively, monitoring for the user action can include monitoring for the user action of changing a user status by indicating a lack of active engagement. Subsequently, the messaging platform system can determine to push the incoming message to the destination device when the user status is changed to indicate the lack of active engagement. As a further example, monitoring for the user action can include monitoring for the user action of signing out of the first user account from the terminal. Subsequently, the messaging platform system can determine to push the incoming message to the destination device when the first user account is signed out from the terminal. Monitoring for the user action can also include determining a movement of the mobile device based at least partly on geolocation reports from the mobile device. Subsequently, the messaging platform system can determine to push the incoming message to the mobile device based on the geolocation reports.

In another scenario, the messaging platform system can determine the terminal type to be a mobile application on a mobile device when the destination device is the mobile device. In that case, monitoring for the user action can include monitoring for the user action of signing in as the first user account through a web browser at a computing device other than the mobile device. Subsequently, the messaging platform system can determine not to push the incoming message to the mobile device.

### Enterprise-Level Broadcast

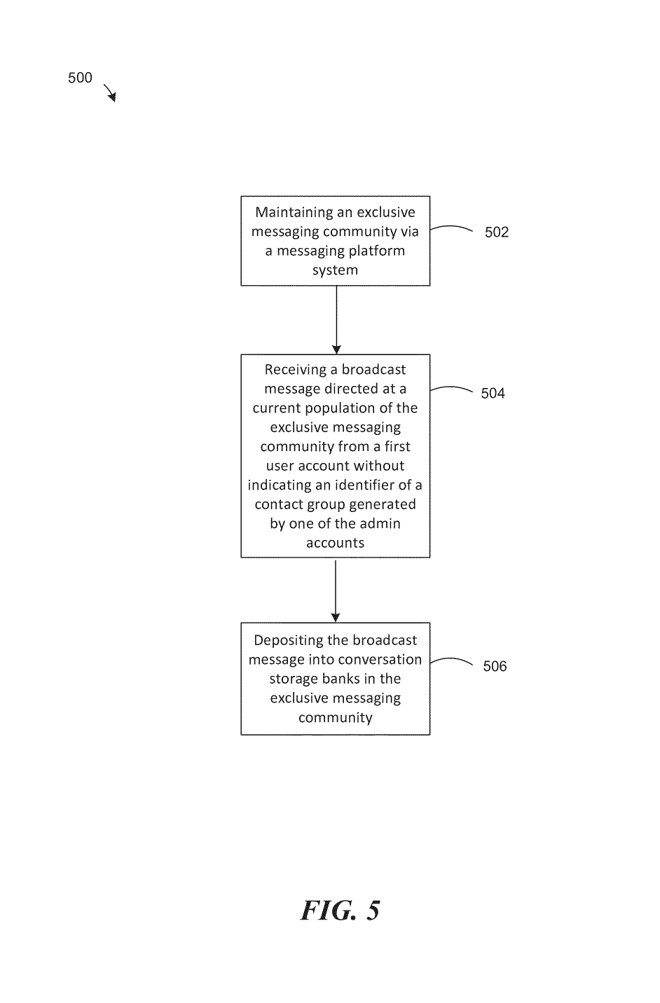

FIG. 5 illustrates a flowchart of a method 500 of operating a messaging platform system for enterprise-level broadcast, in accordance with various embodiments. The method can include: maintaining an exclusive messaging community via a messaging platform system at step 502, wherein one or more admin accounts are enabled to add or remove a user account into or from the exclusive messaging community and to create one or more contact groups by associating individual accounts with the contact groups; receiving a broadcast message directed at a current population of the exclusive messaging community from a first user account without indicating an identifier of a contact group generated by one of the admin accounts at step 504, wherein the broadcast message is configured as multiple one-on-one conversations between the first user account and each of user accounts in the current population; and depositing the broadcast message into conversation storage banks in the exclusive messaging community at step 506, wherein each of the conversation storage banks stores communication only between the first user account and the each user account in the current population.

The first user account can be one of the admin accounts. The method can further include granting the first user account broadcasting privilege by one of the admin accounts through the messaging platform system. In at least one embodiment, the broadcast message is deposited into the conversation storage banks only when the first user account has the broadcasting privilege. The broadcast message can be initiated by the user selecting “all” as the destination of a message. The broadcast message does not have to indicate any identifier of the user accounts or the contact groups in the exclusive messaging community.

The broadcast message is configured as multiple one-on-one messages. For example, the method can further include receiving a reply message from a second user account in the exclusive messaging community in response to the broadcast message and delivering the reply message only to one or more devices associated with the first user account.

### Enterprise Configuration of “Hot Buttons”

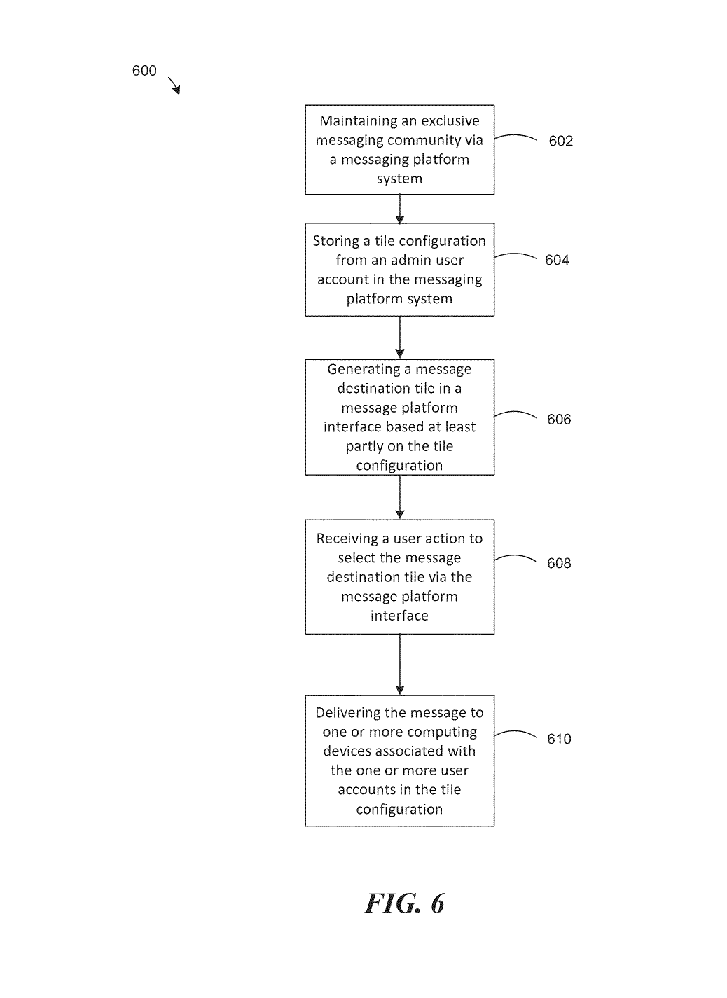

FIG. 6 illustrates a flowchart of a method 600 of operating a messaging platform system for configuring “hot buttons” in an enterprise messaging platform, in accordance with various embodiments. The method can include: maintaining an exclusive messaging community via a messaging platform system at step 602; storing a tile configuration from an admin user account in the messaging platform system at step 604, the tile configuration including a first media file and one or more account identifiers of user accounts in the exclusive messaging community; generating a message destination tile in a message platform interface based at least partly on the tile configuration at step 606; receiving a user action to select the message destination tile via the message platform interface at step 608, wherein the user action is associated with a message; and delivering the message to one or more computing devices associated with the one or more user accounts in the tile configuration at step 610.

The tile configuration can be configured to designate the account identifiers associated with an emergency response team. Delivering the messages can include: determining a subset of the account identifiers as more likely available based at least partly on presence statuses of the account identifiers; and delivering the message to the one or more computing devices of the subset of the account identifiers. The presence statuses can be user-reported status updates or system-determined updates by monitoring user behaviors associated with the account identifiers. The tile configuration can include the first media file and a second media file. When generating the message destination tile, the messaging platform system can display the first media file when the message destination tile is unselected and display the second media file when the message destination tile is selected.

### Centralized Conversation Storage (“Forgetful” Message Display on User Devices)

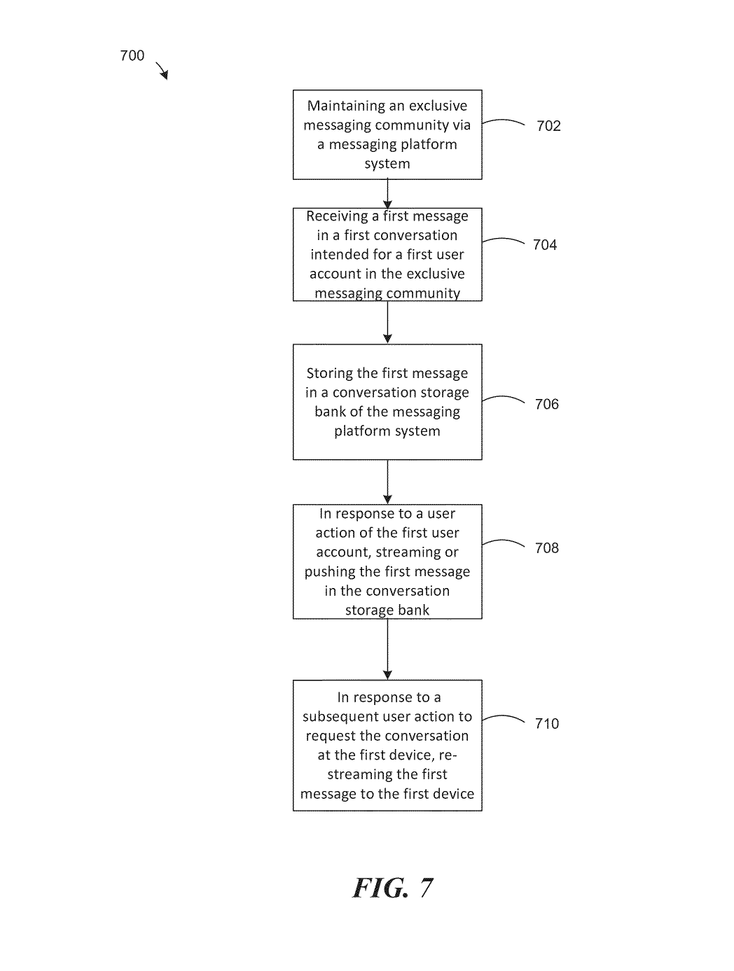

FIG. 7 illustrates a flowchart of a method 700 of operating a messaging platform system to centralize conversation storage, in accordance with various embodiments. The method can include: maintaining an exclusive messaging community via a messaging platform system at step 702; receiving a first message in a first conversation intended for a first user account in the exclusive messaging community at step 704; storing the first message in a conversation storage bank of the messaging platform system at step 706; in response to a user action of the first user account that is logged in to the messaging platform system from a first device, streaming or pushing the first message in the conversation storage bank to the first device at step 708; and in response to a subsequent user action to request the conversation at the first device, re-streaming the first message to the first device at step 710; and wherein the first message is not persistently stored on the first device after the first message is displayed on the first device. The conversation storage bank can be accessible to an admin user account of the exclusive messaging community. The messaging platform system can terminate the first user account. Terminating the first user account can include preventing access by the first user account to the conversation storage bank. The messaging platform system can archive the conversation storage bank such that conversations involving the first user account is accessible after the termination of the first user account.

### Screen Capture Safe Enterprise Messaging System

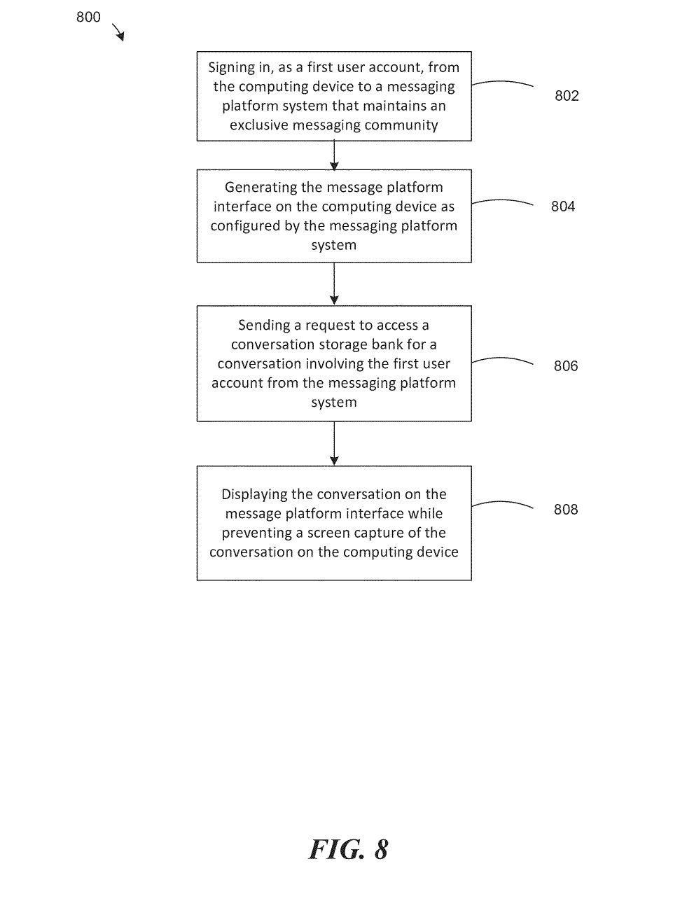

FIG. 8 illustrates a flowchart of a method 800 of operating a message platform interface on a computing device to prevent unauthorized screen captures of enterprise conversations, in accordance with various embodiments. The method can include: signing in, as a first user account, from the computing device to a messaging platform system that maintains an exclusive messaging community at step 802; generating the message platform interface on the computing device as configured by the messaging platform system at step 804; sending a request to access a conversation storage bank for a conversation involving the first user account from the messaging platform system at step 806; and displaying the conversation on the message platform interface while preventing a screen capture of the conversation on the computing device at step 808.

In some embodiments, the message platform interface can prevent the screen capture of the conversation by disabling a functionality of taking a screenshot on the computing device while displaying the conversation. In some embodiments, the message platform interface can prevent the screen capture by detecting taking of a screenshot on the computing device and covering at least a portion of the message platform interface with an alternative display when the screen capture process is detected.

Covering the portion of the message platform interface can include blacking out the portion of the message platform interface. Covering the portion of the message platform interface can also include covering an entire screen of the message platform interface. Covering the portion of the message platform interface can further include covering the portion of the message platform interface that is displaying the conversation. Covering the portion of the message platform interface can yet further include blacking out a display device of the computing device. Detecting the taking of the screenshot can include detecting at least a keystroke for initiating the taking of the screenshot. This keystroke or keystrokes may depend on which operating system (e.g., versions of Android or iOS) the computing devices running.

While processes or methods are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. In addition, while processes or blocks are at times shown as being performed in series, these processes or blocks may instead be performed in parallel, or may be performed at different times.

FIG. 9 is a block schematic diagram that depicts a machine in the exemplary form of a computer system 900, within which a set of instructions for causing the machine to perform any of the herein disclosed methodologies may be executed. For example, the computer system 900 can implement the messaging platform system 100 of FIG. 1 or the messaging platform system 200 of FIG. 2. In alternative embodiments, the machine may comprise or include a network router, a network switch, a network bridge, personal digital assistant (PDA), a cellular telephone, a Web appliance or any machine capable of executing or transmitting a sequence of instructions that specify actions to be taken. The computer system 900 is intended to illustrate a hardware device on which any of the instructions, processes, modules and components depicted in the figures above (and any other processes, techniques, modules and/or components described in this specification) can be implemented. As shown, the computer system 900 includes a processor 902, memory 904, non-volatile memory 906, and a network interface 908. Various common components (e.g., cache memory) are omitted for illustrative simplicity. The computer system 900 can be of any applicable known or convenient type, e.g., a personal computer (PC), server-class computer or mobile device (e.g., smartphone, card reader, tablet computer, etc.). The components of the computer system 900 can be coupled together via a bus and/or through any other known or convenient form of interconnect.

One of ordinary skill in the relevant art will recognize that the terms “machine-readable (storage) medium” or “computer-readable (storage) medium” include any type of device that is accessible by the processor 902. The memory 904 is coupled to the processor 902 by, for example, a bus 910. The memory 904 can include, by way of example but not limitation, random access memory (RAM), e.g., dynamic RAM (DRAM) and static RAM (SRAM). The memory 904 can be local, remote, or distributed.

The bus 910 also couples the processor 902 to the non-volatile memory 906 and drive unit 912. The non-volatile memory 906 may be a hard disk, a magnetic-optical disk, an optical disk, a read-only memory (ROM), e.g., a CD-ROM, Erasable Programmable Read-Only Memory (EPROM), or Electrically Erasable Programmable Read-Only Memory (EEPROM), a magnetic or optical card, or another form of storage for large amounts of data. The non-volatile memory 906 can be local, remote, or distributed.

The data structures, modules, and instruction steps described in the figures above may be stored in the non-volatile memory 906, the drive unit 912, or the memory 904. The processor 902 may execute one or more of the modules stored in the memory components.

The bus 910 also couples the processor 902 to the network interface 908. The network interface 908 can include one or more of a modem or network interface. A modem or network interface can be considered to be part of the computer system 900. The network interface 908 can include an analog modem, ISDN modem, cable modem, token ring interface, satellite transmission interface (e.g., “direct PC”), or other interfaces for coupling a computer system to other computer systems.

It is to be understood that embodiments may be used as or to support software programs or software modules executed upon some form of processing core (e.g., the CPU of a computer) or otherwise implemented or realized upon or within a machine or computer readable medium. A machine-readable medium includes any mechanism for storing or transmitting information in a form readable by a machine, e.g., a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

What is claimed is:

1. A method of operating a messaging platform system, comprising:
receiving a login from a first user account to the messaging platform system from a terminal, the login including login information;
determining a terminal type based at least partly on the login information;
monitoring for a user action at the terminal;
receiving an incoming message for the first user account from a second user account; and
determining whether to push the incoming message to a destination device associated with the first user account based on the monitoring of the user action and the terminal type.

2. The method of claim 1, wherein the terminal type is determined to be a web browser on a computing device and the destination device is a mobile device associated with the first user account.

3. The method of claim 2, wherein monitoring for the user action at the terminal includes monitoring for the user action within a period of time to determine whether the terminal has gone idle; and wherein determining whether to push the incoming message includes determining to push the incoming message to the destination device when the terminal has gone idle.

4. The method of claim 2, wherein monitoring for the user action includes monitoring for the user action of changing a user status by indicating a lack of active engagement; and wherein determining whether to push the incoming message includes determining to push the incoming message to the destination device when the user status is changed to indicate the lack of active engagement.

5. The method of claim 2, wherein monitoring for the user action includes monitoring for the user action of signing out of the first user account from the terminal; and wherein determining whether to push the incoming message includes determining to push the incoming message to the destination device when the first user account is signed out from the terminal.

6. The method of claim 2, wherein monitoring for the user action includes determining a movement of the mobile device based at least partly on geolocation reports from the mobile device; and wherein determining whether to push the incoming message includes determining to push the incoming message to the mobile device.

7. The method of claim 1, wherein the terminal type is determined to be a mobile application on a mobile device and the destination device is the mobile device.

8. The method of claim 7, wherein monitoring for the user action includes monitoring for the user action of signing in as the first user account through a web browser at a computing device other than the mobile device; and wherein determining whether to push the incoming message includes determining not to push the incoming message to the mobile device.

9. A method of operating a messaging platform system, comprising:
maintaining an exclusive messaging community via a messaging platform system, wherein one or more admin accounts are enabled to add or remove a user account into or from the exclusive messaging community and to create one or more contact groups by associating individual accounts with the contact groups;
receiving a broadcast message directed at a current population of the exclusive messaging community from a first user account without indicating an identifier of a contact group generated by one of the admin accounts, wherein the broadcast message is configured as multiple one-on-one conversations between the first user account and each of user accounts in the current population; and
depositing the broadcast message into conversation storage banks in the exclusive messaging community, wherein each of the conversation storage banks stores communication only between the first user account and the each user account in the current population.

10. The method of claim 9, wherein the first user account is one of the admin accounts.

11. The method of claim 9, further comprising granting the first user account broadcasting privilege by one of the admin accounts through the messaging platform system, wherein the broadcast message is deposited into the conversation storage banks only when the first user account has the broadcasting privilege.

12. The method of claim 9, wherein the broadcast message does not indicate any identifier of the user accounts or the contact groups in the exclusive messaging community.

13. The method of claim 9, further comprising:
receiving a reply message from a second user account in the exclusive messaging community in response to the broadcast message; and
delivering the reply message only to one or more devices associated with the first user account.

14. A method of operating a messaging platform system, comprising:
maintaining an exclusive messaging community via a messaging platform system;
storing a tile configuration from an admin user account in the messaging platform system, the tile configuration including a first media file and one or more account identifiers of user accounts in the exclusive messaging community;
generating a message destination tile in a message platform interface based at least partly on the tile configuration;
receiving a user action to select the message destination tile via the message platform interface, wherein the user action is associated with a message; and
delivering the message to one or more computing devices associated with the one or more user accounts in the tile configuration.

15. The method of claim 14, wherein tile configuration is configured to designate the account identifiers associated with an emergency response team.

16. The method of claim 14, wherein delivering the messages includes:
determining a subset of the account identifiers as more likely available based at least partly on presence statuses of the account identifiers; and
delivering the message to the one or more computing devices of the subset of the account identifiers.

17. The method of claim 16, wherein the presence statuses are user-reported or determined based on a user behavior monitored by the messaging platform system.

18. The method of claim 14, wherein tile configuration includes the first media file and a second media file, wherein generating the message destination tile includes displaying the first media file when the message destination tile is unselected and displaying the second media file when the message destination tile is selected.

19. A method of operating a messaging platform system, comprising:
maintaining an exclusive messaging community via a messaging platform system;
receiving a first message in a first conversation intended for a first user account in the exclusive messaging community;
storing the first message in a conversation storage bank of the messaging platform system;
in response to a user action of the first user account that is logged in to the messaging platform system from a first device, streaming or pushing the first message in the conversation storage bank to the first device; and
in response to a subsequent user action to request the conversation at the first device, re-streaming the first message to the first device; and
wherein the first message is not persistently stored on the first device after the first message is displayed on the first device.

20. The method of claim 19, wherein the conversation storage bank is accessible to an admin user account of the exclusive messaging community.

21. The method of claim 19, further comprising:
terminating the first user account, wherein terminating the first user account includes:
preventing access by the first user account to the conversation storage bank; and
archiving the conversation storage bank even after the terminating of the first user account.

22. A method of operating a message platform interface on a computing device, comprising:
signing in as a first user account from the computing device to a messaging platform system maintaining an exclusive messaging community;
generating the message platform interface on the computing device as configured by the messaging platform system;
sending a request to access a conversation storage bank for a conversation involving the first user account from the messaging platform system; and
displaying the conversation on the message platform interface while preventing a screen capture of the conversation on the computing device.

23. The method of claim 22, wherein preventing the screen capture of the conversation includes disabling a functionality of taking a screenshot on the computing device while displaying the conversation.

24. The method of claim 22, wherein preventing the screen capture of the conversation includes, in response to detecting taking of a screenshot on the computing device, covering at least a portion of the message platform interface with an alternative display.

25. The method of claim 23, wherein covering the portion of the message platform interface includes blacking out the portion of the message platform interface.

26. The method of claim 23, wherein detecting the taking of the screenshot includes detecting at least a keystroke for initiating the taking of the screenshot.

27. The method of claim 23, wherein covering the portion of the message platform interface includes covering an entire screen of the message platform interface.

28. The method of claim 23, wherein covering the portion of the message platform interface includes covering the portion of the message platform interface that is displaying the conversation.

29. The method of claim 23, wherein covering the portion of the message platform interface includes blacking out a display device of the computing device.
